(19) United States
(12) Patent Application Publication
(10) Pub. No.: US 2006/0043343 A1
(43) Pub. Date: Mar. 2, 2006

(54) Polymer composition and film having positive temperature coefficient

(76) Inventor: Antony P. Chacko, Granger, IN (US)

Correspondence Address: CTS CORPORATION, 905 W. BLVD. N, ELKHART, IN, 46514, US

(21) Appl. No.: 10/924,634

(22) Filed: Aug. 24, 2004

(51) Int. Cl. H01B 1/12

(52) U.S. Cl. 252/500

(57) ABSTRACT

A resistive composition that has a positive temperature coefficient with an increased resistance change over temperature. The composition, based on total composition includes 5-30 wt. % of polymer resin and 10-50 wt. % conductive particles and 30-60 wt. % organic solvent. The polymer resin and conductive particles are dispersed in the organic solvent. The conductive particles are selected from the group consisting of milled carbon fibers, milled vapor grown carbon fibers, milled carbon nanotubes and mixtures thereof. The resistive composition can be used to make an applied film for a mirror heater.

### BACKGROUND

This invention generally relates to polymer resistor compositions having positive temperature coefficients (PTC). In particular, the invention is directed to such compositions, which are suitable for making heaters such as those used in automobile and vehicle mirrors.

Electrically resistive thick film compositions have numerous applications. Polymer thick film resistive compositions are screenable pastes, which are used to form resistive elements in various applications. Such compositions contain conductive filler material dispersed in polymeric resins, which remain an integral part of the final composition after processing.

Electrically resistive compositions and coatings that exhibit PTC behavior are useful for self-regulating heaters such as in automobile mirrors. These materials show a rapid increase in resistance as a function of temperature.

Automobile mirror heaters of the prior art have been screen printed onto flexible polyester substrates and attached to mirrors with an adhesive backing. The heaters are typically made with a thermoplastic carbon ink having a positive temperature coefficient. These heaters are said to be self-regulating because as the heater warms up, its resistance increases, thereby reducing power applied to the heater.

In practice, these heaters have not been able to function alone because the resistance change is not great enough to turn off the power. In a car, when the ignition is on, if the heater is not connected through a thermal switch or a timer, the heater draws power continuously whether it is needed or not. The continuous draw of power can lead to a dead battery in the vehicle. In addition, continuously operating the mirror heater accelerates aging of the mirror heater. Automobile mirror heaters are susceptible to premature failure unless they are fitted with thermal switches or timers.

Unfortunately, the use of the timers or thermal switches increases the cost and complexity of the mirror heater. Continuously operating the mirror heater leads to premature failure and unnecessary energy consumption.

PTC compositions have been used in various applications. An example of a prior art composition is as follows:

### Prior Art PTC Composition

| Component | Weight (%) |
|---|---|
| PVDF copolymer (Kynar 9300) | 30 |
| Carbon Black (Black Pearls L) | 12 |
| N-methyl pyrrolidone | 57 |

Unfortunately, the prior art composition has a low change in resistance with temperature.

A current unmet need exists for a screen printable polymer resistor composition, which can be directly printed over mirror substrates with good adhesion to substrate, with good mechanical properties, and with a positive temperature coefficient that has an increased resistance change with temperature.

### SUMMARY OF THE INVENTION

The present invention provides a resistive composition that has a positive temperature coefficient with an increased resistance change over temperature.

The present invention also provides a resistive composition, based on total composition includes 5-30 wt. % of polymer resin and 10-50 wt. % conductive particles and 30-60 wt. % organic solvent. The polymer resin and conductive particles are dispersed in the organic solvent. The conductive particles are selected from the group consisting of milled carbon fibers, milled vapor grown carbon fibers, milled carbon nanotubes and mixtures thereof.

The present invention further provides a screenable resistive composition.

The present invention further provides an applied resistive film that has 40-80 percent by weight of a cured polymer resin and 10-50 percent by weight of conductive particles. The conductive particles are selected from the group consisting of milled carbon fibers, milled vapor grown carbon fibers, milled carbon nanotubes and mixtures thereof.

### BRIEF DESCRIPTION OF THE DRAWINGS

FIG. 1 shows a comparison between the PTC properties of a prior art composition and the composition of the present invention.

FIG. 2 shows a comparison of the PTC properties of the present invention and the prior art composition when used in a mirror heater.

FIG. 3 shows the self limiting temperature properties of the prior art composition as used on a mirror heater.

FIG. 4 shows the self limiting temperature properties of the present invention as used on a mirror heater.

### DETAILED DESCRIPTION

According to a preferred embodiment of the invention, a PTC composition for screen printing onto a substrate will now be described. In particular, the composition includes polymer components, electrically conductive components and other additives. The composition is carried by an organic vehicle. The details of all these components, its method of preparation, and associated printing procedures are discussed below.

### Electrically Conductive Components

The electrically conductive component of the present invention comprises finely milled particles of electrically conductive materials such as milled carbon fibers, milled vapor grown carbon fibers (VGCF), milled carbon nanotubes, and similar conductive particles. The preferred particles are milled carbon fibers. The preferred conductive particles comprise 10-50 wt. % of the conductive composition, with a most preferred range of 15-25 wt. %.

The amount and the particle size of the carbon fibers determine the resistivity of the PTC film. The milled carbon fibers are processed to obtain the desired particle size and distribution.

As an option, metallic particles such as silver or nickel can be blended with the carbon fibers for application that require a low resistivity films.

### Polymer Components

Polymers that can be dissolved in common high boiling screen printing solvents and have some level of crystallanity can be used in the present composition. One such polymer is polyvinylidene flouride copolymer (PVDF). Some PVDF copolymers have good solubility in screen printing solvents such as N-methyl pyrrolidone.

The selection of a particular type of polymer depends on its solubility and its phase transition in the temperature of application. Polyvinylidene flouride copolymer such as Kynar 9301 have a melting point around 90 degrees Centigrade. In comparison, Kynar 711 has a melting point around 165 degrees Centigrade. Both of these polymers are soluble in N-methyl pyrrolidone. In addition to PVDF copolymers, other polymers such as ethylene vinyl acetate copolymers, ethylene-acrylic ester-maleic acid terpolymers can be used.

In the composition of the present invention, the polymer is used in the range of 5-35 wt. % by weight of the conductive composition, with a more preferred range of 15-30 wt. %. If less than 5 wt. % polymer is used, the resulting conductive composition has been found to have poor screen printing properties, as well as weak mechanical properties and poor adhesion. If more than 35 wt. % polymer is used, the resulting composition has a lower than desirable electrical conductive property.

### Other Additives

Rheological additives, dispersion enhancing additives, and antifoaming agents are used enhance the screen printing properties and surface properties of the screen printed film or coated PTC film. Rheological additives such as butvar B-72 and thixatrol plus can be used. Air can be entrapped in the composition during processing. Antifoaming additives, such as Antifoam-A, can be used to inhibit any film defects due to foaming. The adhesion properties of the PTC coatings to various substrates can be improved by incorporating coupling agents in the composition.

### Organic Vehicle

An organic solvent of 30-60 weight % is used to dissolve the resistive composition. The preferred solvent is N-methyl pyrrolidone. The selection of the solvent is based on the good solubility of the polymer in this solvent. This solvent also has a high boiling point. Low evaporation of the solvent is preferred for continuous printing operation where no change in viscosity of the composition due to loss of solvent is desired. The polymer is dissolved completely in the organic vehicle prior to blending with the other components. N-methyl pyrrolidone is commercially available from BASF Corporation. Other solvents such as glycol ether DB or diallyl isopthalate can used alone or in combination depending on the solubility of the polymer.

### General Composition Preparation and Printing Procedures

In the preparation of an exemplary composition of the present invention, a polymer solution is made by mixing 25-35 wt. % of a polymer in 65-75 wt. % N-methyl pyrrolidone based upon total composition. The polymer solution is then mixed with the conductive particles, surfactants and Theological additives.

The paste is mixed by ball milling. Other methods of mixing could be used, such as high speed shear mixing, roller milling etc can be used. High speed shear mixing involves relatively short processing time compared to ball milling.

The resistive paste thus prepared is applied to substrates such as polyimide, ceramic, glass, mirrors, fiber reinforced substrates, and plastic substrates by conventional screen printing processes. The wet film thickness typically used for is 40 microns. The wet film thickness is determined by the screen mesh and screen emulsion thickness or stencil wire dimensions. The paste can be applied to substrates by screen printing, stencil printing, or other coating methods. The preferred method is stencil printing. The substrates may be pretreated with a silane coupling agents to enhance adhesion. The paste is then air dried and cured resulting in a PTC film on the substrate.

### EXAMPLES

The present invention will be described in further detail by giving practical examples. The scope of the present invention, however, is not limited in any way by these practical examples. All component concentrations are expressed as percentage by weight based on total composition.

### Example 1

| Component | Weight (%) |
|---|---|
| Polyvinylidene flouride copolymer (PVDF) | 27 |
| (Kynar 9300) | |
| Milled carbon fibers | 20 |
| N-methyl pyrrolidone | 53 |

### Example 2

| Component | Weight (%) |
|---|---|
| PVDF copolymer (Kynar 711) | 27 |
| Milled carbon fibers | 20 |
| N-methyl pyrrolidone | 53 |

### Example 3

| Component | Weight (%) |
|---|---|
| PVDF copolymer (Kynar 9300) | 27 |
| Milled carbon fibers | 15 |
| Milled VGCF | 5 |
| Antifoam A | .01 |
| Butvar B-72 | 0.14 |
| N-methyl pyrrolidone | 53 |

### Example 4

| Component | Weight (%) |
|---|---|
| PVDF copolymer (Kynar 711) | 27 |
| Milled carbon fibers | 15 |
| Milled carbon nanotubes | 5 |
| Antifoam A | .01 |
| Butvar B-72 | 0.14 |
| N-methyl pyrrolidone | 53 |

### Example 5

| Component | Weight (%) |
|---|---|
| PVDF copolymer (Kynar 711) | 27 |
| Milled carbon fibers | 15 |
| Milled VGCF | 5 |
| Antifoam A | .01 |
| N-methyl pyrrolidone | 53 |

Materials Sources
PVDF copolymer can be obtained from Atofina.
Polyimide can be obtained from Dupont Corp.
Diallylyl isopthalate can be obtained from DAISO Corp.
Carbon Nanotubes can be obtained from Carbolex Corp.
Vapor grown carbon nano fibers can be obtained from Applied Sciences Corp.
Milled carbon fibers can be obtained from Zoltech Corp.
Wetting agent can be obtained from Dow Chemicals.
   Cured PTC Resistive Coating and Film

The positive temperature coefficient composition (PTC) of the present invention was applied to a substrate and cured resulting in a cured PTC film. The present invention further provides an applied resistive film that has 40-80 percent by weight of a cured polymer resin and 10-50 percent by weight of conductive particles. The conductive particles include milled carbon fibers, milled vapor grown carbon fibers, milled carbon nanotubes and mixtures thereof.

The composition of the cured film resulting from the example compositions are shown in the following table. All component concentrations are expressed as percentage by weight based on total composition.

| | | | Vapor | | | |
|---|---|---|---|---|---|---|
| | | Milled | grown | | | |
| | | carbon | carbon | Nano | Antifoam | Butvar |
| | PVDF | fibers | fibers | Tubes | A | B-72 |
| Example | (wt. %) | (wt. %) | (wt. %) | (wt. %) | (wt. %) | (wt. %) |
| Example 1 | 57 | 43 | | | | |
| Example 2 | 57 | 43 | | | | .035 |
| Example 3 | 49.75 | 37.41 | 12.47 | 2.33 | .025 | .035 |
| Example 4 | 49.75 | 37.41 | | 12.47 | .025 | .035 |
| Example 5 | 49.92 | 37.54 | 12.51 | | .03 | |

Testing

The cured film resulting from the composition of the present invention was tested for resistance change with temperature and temperature change over time. The resistance of the cured PTC film was measured as a function of temperature.

The films for these measurements were prepared by printing the PTC composition first on mirror substrates dried followed by printing a silver conductive composition of a particular pattern to get the required resistance.

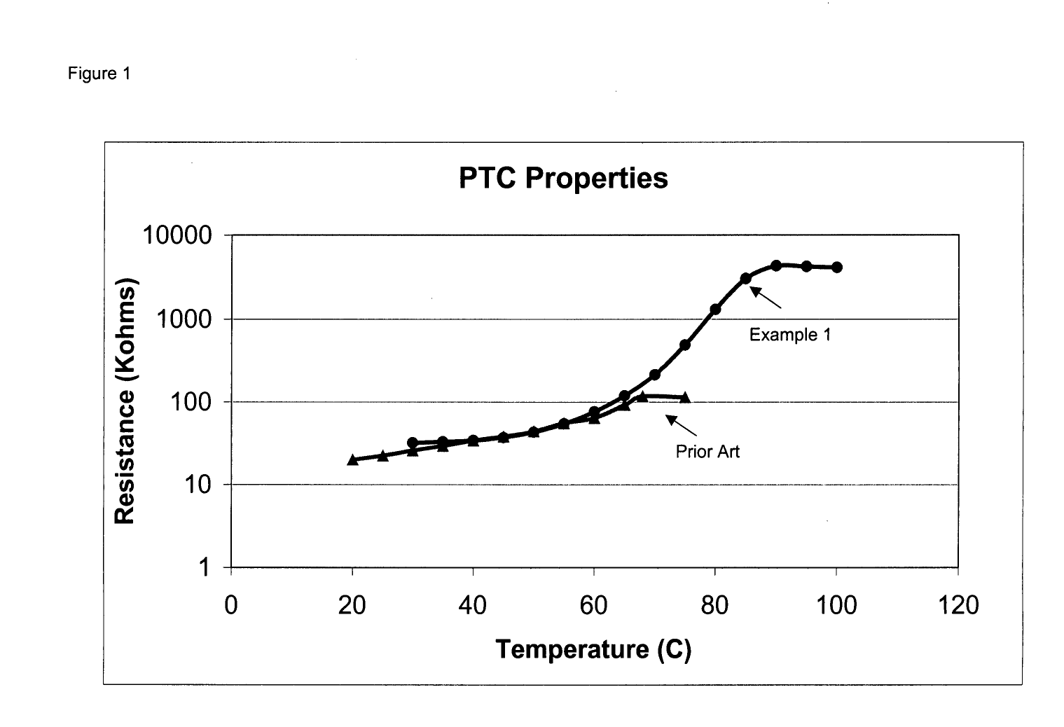

Referring to FIG. 1, a comparison of the PTC properties of the prior art composition containing carbon black with the composition of example 1 is shown. The graph shows that the change in resistance with temperature was greatly increased by an order of magnitude.

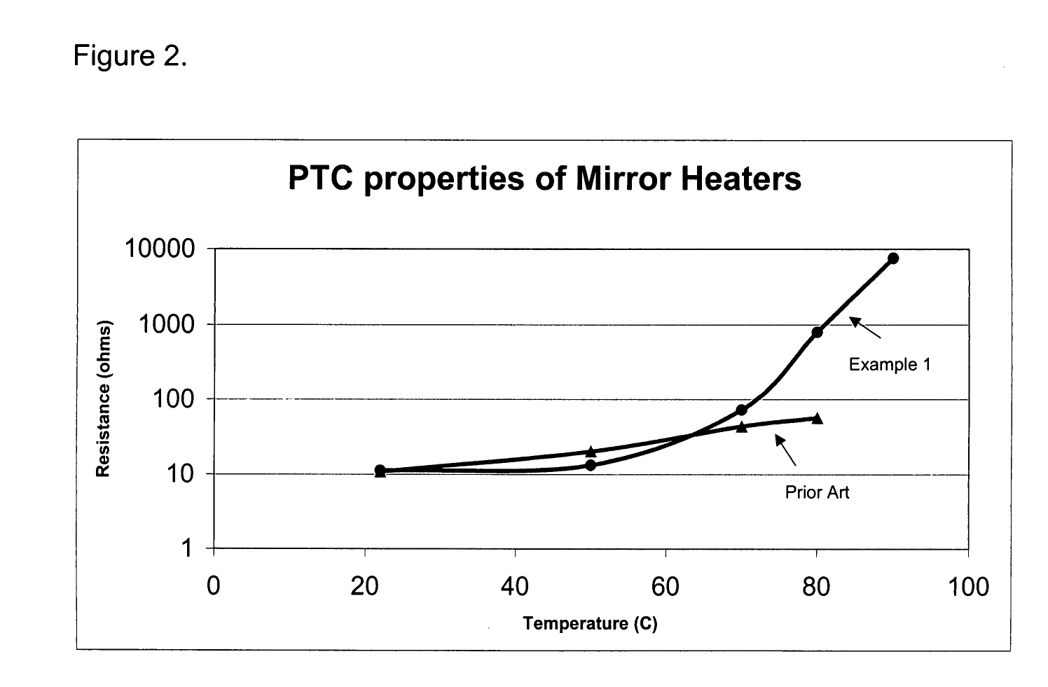

Referring to FIG. 2, a comparison of PTC properties of the present invention example 1 and the prior art composition as used in a mirror heater is shown. The PTC composition of the present invention shows significantly higher changes in resistance with temperature.

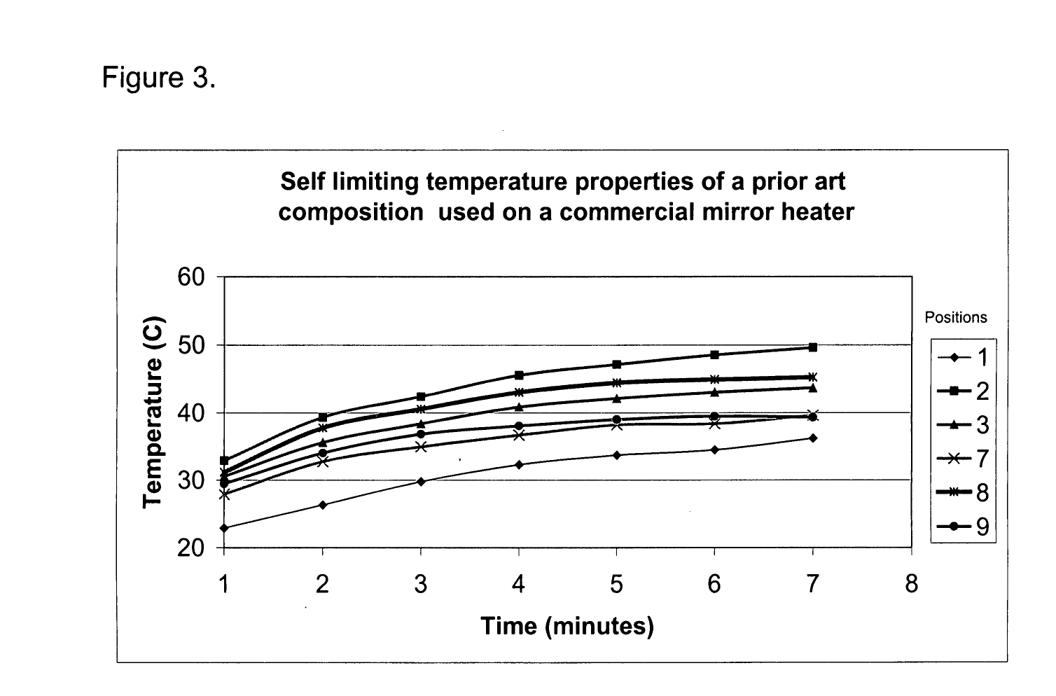

Turning now to FIG. 3, the self-limiting temperature properties of the prior art composition as used on a mirror heater is shown. FIG. 3 shows a graph of temperature versus time. The temperature was measured by using by applying 13.5 vdc +−1vdc to terminals connected across the resistor made by the composition on the mirror. Thermal images were obtained of the reflective surface at one minute intervals at various locations (positions 1 to 9) on the mirror. FIG. 3 shows a non-uniform distribution of temperatures across the mirror surface.

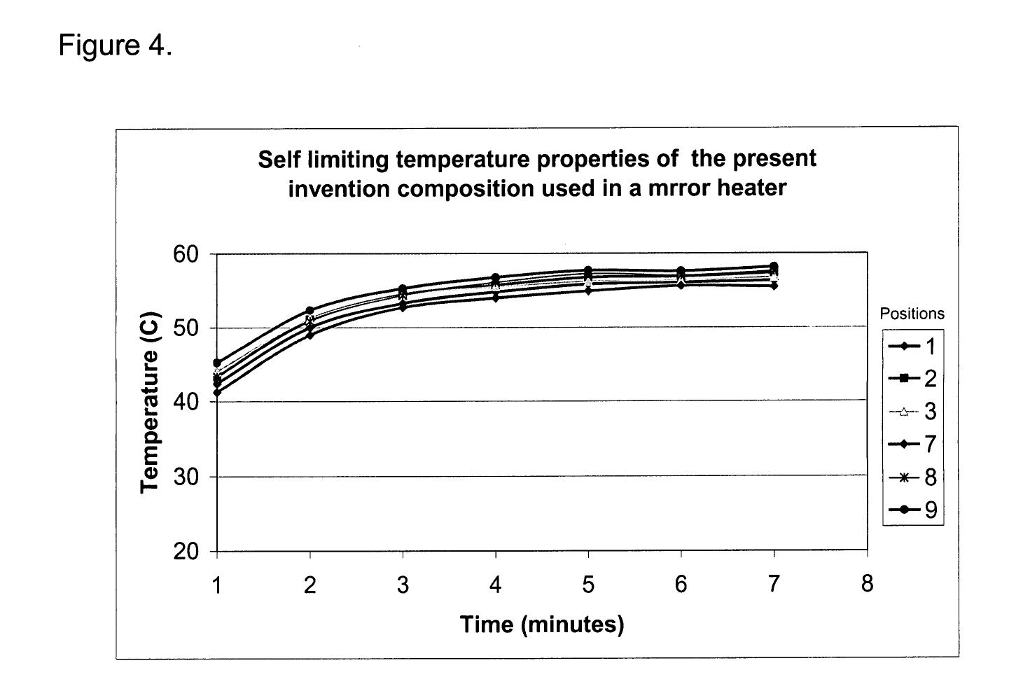

Turning now to FIG. 4, the self-limiting temperature properties of the present invention example 1 as used on a mirror heater is shown. As in FIG. 3, the temperature was measured by using by applying 13.5 vdc+−1vdc to terminals connected across the resistor made by the composition on the mirror. FIG. 4 shows a very uniform distribution of temperatures across the mirror surface.

Discussion

The use of carbon fibers in the composition of the present invention provides an improvement in the resistance change with temperature. The carbon fibers increase the resistance response to a change in temperature.

There are applications where PTC materials need to be resistant to abrasion, impact and related mechanical stresses. The present invention using carbon fibers provides an improvement in mechanical properties.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A resistive composition, based on total composition, comprising:
a) 5-30 wt. % of polymer resin;
b) 10-60 wt. % conductive particles selected from the group consisting of milled carbon fibers, milled vapor grown carbon fibers, milled carbon nanotubes, silver particles, nickel particles and mixtures thereof; and
d) 30-60 wt. % organic solvent, wherein the polymer resin and conductive particles are dispersed in the organic solvent.

2. The resistive composition of claim 1, further comprising: 15-25 wt. % polymer resin.

3. The resistive composition of claim 1, further comprising: 15-25 wt. % conductive particles.

4. The resistive composition of claim 1, wherein the polymer resin is chosen from the group consisting of polyvinylidene flouride copolymer, ethylene vinyl acetate copolymer and ethylene-acrylic ester-maleic acid terpolymer.

5. The resistive composition of claim 1, wherein the organic solvent is chosen from the group consisting of n-methyl pyrrolidone, glycol ether DB, and diallyl phosphate.

6. The resistive composition according to claim 1, wherein the resistive composition is applied to a substrate by screen printing.

7. The resistive composition according to claim 1, wherein the resistive composition is applied to a substrate by stencil printing.

8. The resistive composition according to claim 1, wherein the resistive composition is applied to a substrate, the substrate being selected from the group consisting of polyimide, polyester, ceramic and glass substrates.

9. The resistive composition according to claim 1, wherein the resistive composition exhibits a positive temperature coefficient of resistance.

10. An applied resistive film comprising:
a) 40-80 percent by weight of a cured polymer resin; and
b) 10-50 percent by weight of conductive particles selected from the group consisting of milled carbon fibers, milled vapor grown carbon fibers, milled carbon nanotubes and mixtures thereof.

11. The film according to claim 10, further comprising: 35-45 percent by weight conductive particles.

12. The film according to claim 10, wherein the cured polymer resin is chosen from the group consisting of polyvinylidene flouride copolymer, ethylene vinyl acetate copolymer and ethylene-acrylic ester-maleic acid terpolymer.

13. The film according to claim 10, wherein the cured polymer resin exhibits a melting temperature between 80 and 200 degrees centigrade.

14. The resistive composition according to claim 10, wherein the resistive film exhibits a positive temperature coefficient of resistance.

15. The film according to claim 10, wherein the film is disposed on a substrate.

16. The film according to claim 15, wherein the substrate is glass.

17. The film according to claim 15 wherein the substrate is a mirror.

18. The film according to claim 15 wherein the substrate is treated with a silane coupling agent.
